(19) United States
(12) Patent Application Publication
(10) Pub. No.: US 2009/0304086 A1
(43) Pub. Date: Dec. 10, 2009

(54) METHOD AND SYSTEM FOR VIDEO CODER AND DECODER JOINT OPTIMIZATION

(75) Inventors: Xiaojin SHI, Fremont, CA (US); Hsi-Jung WU, San Jose, CA (US)

Correspondence Address: KENYON & KENYON LLP, 1500 K STREET NW, SUITE 700, WASHINGTON, DC, 20005-1257, US

(73) Assignee: APPLE INC., Cupertino, CA (US)

(21) Appl. No.: 12/466,962

(22) Filed: May 15, 2009

Related U.S. Application Data
(60) Provisional application No. 61/059,725, filed on Jun. 6, 2008.

(51) Int. Cl. H04N 7/12

(52) U.S. Cl. 375/240.24; 375/E07.026

(57) ABSTRACT

Embodiments of the present invention provide apparatuses and methods of coding video. The apparatuses and methods may further provide coding a source video sequence according to a block-based coding process, estimating processing capabilities of a target decoder, determining if the estimated processing capabilities are sufficient to perform deblocking filtering. If not sufficient, the apparatuses and methods may provide computing deblocking filter strengths for pixel blocks of the source video sequence to be used at decoding, and transmitting the deblocking filter strengths in a coded video data signal with the coded video data. Moreover, if not sufficient, the apparatuses and methods may provide changing coding parameters including, but not limited to, block sizes, transform sizes, and Qmatrix.

### CROSS REFERENCE TO RELATED APPLICATIONS

This application claims priority under 35 U.S.C. 119(e) to U.S. Provisional Application 61/059,725, filed on Jun. 6, 2008, entitled “Method and System for Joint Optimization of Complexity and Visual Quality of the Deblocking Process for Resource Limited Devices”.

### FIELD OF THE INVENTION

Embodiments of the present invention relate to video coding and decoding. Specifically, the present invention is related to apparatuses and methods for improving deblocking at a resource-limited decoder.

### BACKGROUND

Video coders are commonly used to code source video to achieve bandwidth compression. The coded video data may be transmitted as a bitstream over communication channels, e.g., the Internet or cable network, to receiving devices. The receiving devices such as a handheld device may decode the received bitstream, recover a replica of the source video and display the recovered video on a display screen.

The process of coding, transmitting, and decoding may be lossy in the sense that the recovered video data at the receiving device is not identical to the video data input at the coding device. The losses in video coding and decoding may arise from the quantization process and/or other operations that induce data compression but at the cost of data loss. Moreover, losses in video coding and decoding may cause visually perceivable artifacts in the recovered video data. One type of well known artifacts in video compression is the so-called blocking artifact often existing in block based coders, e.g., MPEG-x or H.264 coders. Block-based coders typically organize source video data into arrays (or “pixel blocks”) before processing them; when coded blocks are recovered, discontinuities may be observed between recovered pixels blocks which may appear unnatural to viewers.

The blocking artifacts may be reduced in a post processing step performed by a decoder, for example by a low pass filter. Recent video compression standards, e.g. H.264, may also include in-loop deblocking filters in the decoder. FIG. 1 illustrates a functional block diagram of source video data 110 being coded by a coder 120, transmitted across a channel 130, and then decoded by a decoder 140 to produce decoded video data 160. The source video data 110 may be a video digitized from analog or uncompressed video. The source video may commonly contain a sequence of image frames, each of which may include a rectangular array of pixels. The coder 120 may code the source video data 110 to generate coded video data 170 and transmit the coded video data 170 over a communication channel 130 to a decoder 140. The coder may divide the coded video data into slices (136, 142) of pixels. The coded video data may include both coded image frames and instructions (135, 141) that instruct the decoder 140 how to decode the coded video data. The decoder 140 may decode the coded video data based on these instructions.

The coding process may operate as follows. The coder 120 may break up the source video data 110 into slices and then break up the slices into blocks (e.g. 4×4 pixels or 8×8 pixels or 16×16 pixels). The coder 120 may use various coding methods to code the source video data 110. For example, the coder 120 may predict pixel values of a block from a previous block and code the differences between the pixel values and the predicted pixel values based on blocks of pixels. The coder may select coding parameters 132, 138, which may be used to achieve different types and levels of compression and which are communicated to a decoder. These control parameters may determine how much loss is induced to the coding process and thus determines the quality of the decoded video data 160. For example, the coder 120 may have control parameters for a discrete cosine transform (DCT) processor 122, a quantization processor 124, a slice scan system 126, and an entropy coder 128. In particular, the coder 120 may select a coding parameter 132, 134 for the quantization process 124 which determines how many levels a block of the source video data 110 may be quantized. A smaller number of quantization levels may increase the number of zeros and thus permit greater compression. The data that is turned into zeros is lost, but the coded video data 170 is compressed.

For block based video compression, blocking artifacts may exist because of the quantization of pixel values. Blocking artifacts are a distortion that appears in the decoded video as abnormally large pixel blocks. For example, a video image may appear to have large blocks, or black or white lines, or an image may appear to have blocks that are averaged together. Typically, the blocking artifacts may occur with pixels surrounding the output of certain decoded blocks of pixels.

The decoder 140 may include a deblocking filter 150 to reduce blocking artifacts. The deblocking filter in the decoder may have a number of control parameters. For example, under H.264 (“Advanced Video Coding for Generic Audiovisual Services”, ITU-T Rec. H.264 (11/2007), which is incorporated herein by reference), the strength of an in-loop deblocking filter in the decoder may be controlled globally by parameters representing quantization levels in the bitstream. The coder may set these global deblocking filter parameters during coding process, for example, during coding slices of video data 136, 142.

The decoder 140 may operate as follows. The decoder 140 receives the coded video data 170 including coding parameters 132 and deblocking filter parameters 134. The decoder 140 then decodes the coded video data 170, block-by-block, according to the coding parameters 132, 138 and the deblocking filter parameters 134. The coding parameters 132, 138 determine how to decode the coded video data 170 for the entropy decoder 142, the inverse slice scan system 144, the inverse quantization processor 146, and the inverse DCT processor 148.

The deblocking filter 150 may operate as follows. The coder 120 may globally control the strength of the deblocking filter 150 at slice level, e.g., via the alpha and beta parameters of the H.264 standard, where the alpha and beta may be determined based on the average quantization parameter of a slice. However, since the coder 120 has only a slice level control over the deblocking filter 150, some pixel blocks within the slice may be over-filtered and some blocks within the slice may be under-filtered. Over-filtering may over-smooth the decoded video data 160, e.g., blurring edges, and reduce the perceptual quality of the video. On the other hand, under filtering may not sufficiently reduce blocking artifacts.

Thus, in addition to the global control of deblocking filter, a decoder may compute a deblocking filter strength for each pixel block based on image content or pixel values within and without the pixel block. For example, under H.264, four levels of deblocking filter strengths (bS) may be computed based on pixel values and location of block edges. A level four (bS=4) represents the strongest filtering, and a level one (bS=1) represents the least filtering. Under this arrangement, the filtering is more targeted to each block, which may produce right amount of filtering for the block. However, the block-based deblocking filtering may require the decoder to compute the proper amount of deblocking strength. This computation may burden receiving devices that have only limited computation resources. For these devices, the extra computational burden may cause the decoder, e.g., to drop frames and thus reduce the visual quality.

Moreover, the receiving device may include processors, e.g., CPU or GPU that may operate in parallel. However, data dependencies in the coded video data 170 may prevent the deblocking to be performed in parallel. For example, as in predicting coding, a pixel block to be filtered may be calculated with pixel values from previous pixel blocks and/or later pixel blocks in a coding sequence. Thus, parallel processing may not happen since later pixel blocks that the current pixel block depends on have not finished processing yet.

Accordingly, there is a need for apparatuses and methods to efficiently control the deblocking applied at a block level. Moreover, there is a need in the art to jointly manage a complex budget for a deblocking filter, and to code video source data that can be deblock-filtered in parallel.

### BRIEF DESCRIPTION OF THE DRAWINGS

FIG. 1 illustrates a functional block diagram of a source video data being coded, transmitted across a channel, and then decoded to produce a decoded video data.

FIG. 2 illustrates a coded image that is split into slices.

FIG. 3A illustrates a slice of an image with the deblocking filter parameters and the coding parameters.

FIG. 3B illustrates a tuple of pixels over a pixel block edge over which a deblocking filter may apply.

FIG. 3C illustrates one block in a slice.

FIG. 4A illustrates a slice of coded video data with data dependencies.

FIG. 4B illustrates the data dependencies having been removed.

FIG. 4C illustrates the data dependencies between adjacent deblocking filters.

FIG. 5 illustrates an embodiment for a method for joint optimization of complexity and visual quality of the deblocking process for resource limited decoders.

FIG. 6 illustrates another embodiment for a method for joint optimization of complexity and visual quality of the deblocking process for resource limited decoders.

FIG. 7 illustrates a simplified functional block diagram of a computer system that may be used to implement the coding method illustrated in FIGS. 5 and 6.

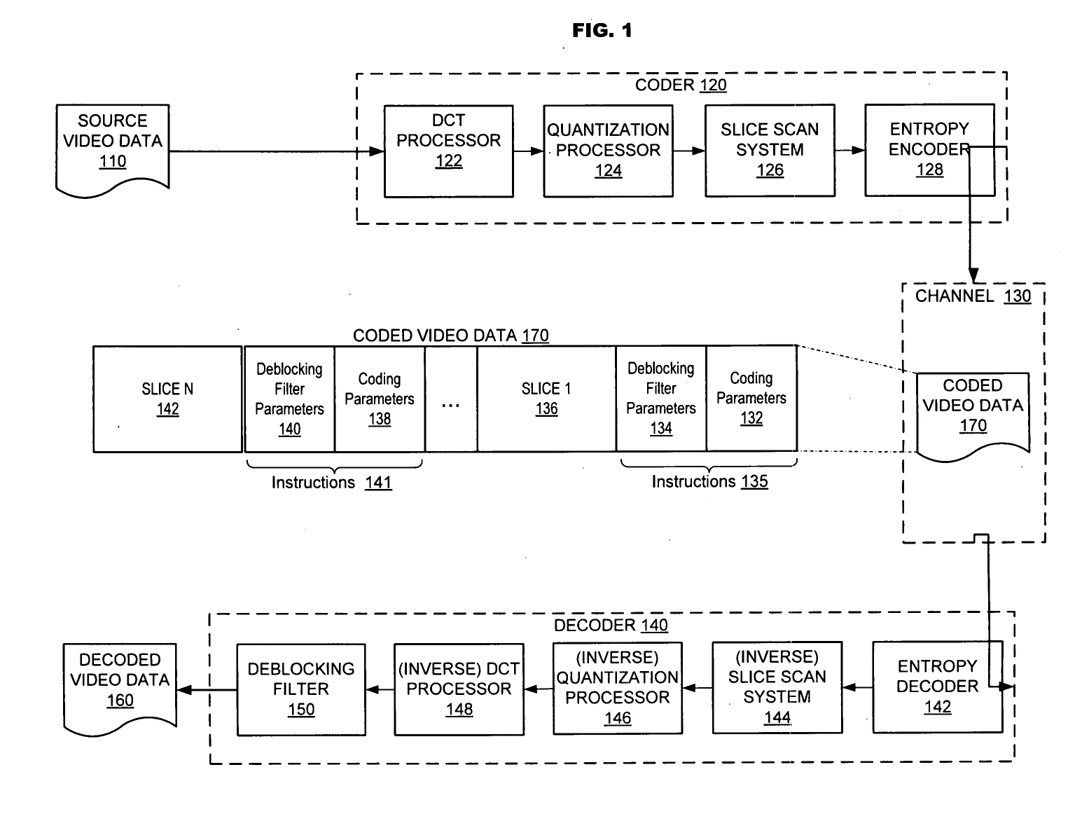

### DETAILED DESCRIPTION

Embodiments of the present invention provide apparatuses and methods of coding video. The apparatuses and methods further provide coding a source video sequence according to a block-based coding process, estimating processing capabilities of a target decoder, determining if the estimated processing capabilities are sufficient to perform deblocking filtering. If not sufficient, the apparatuses and methods further provide computing deblocking filter strengths for pixel blocks of the source video sequence to be used at decoding, and transmitting the deblocking filter strengths in a coded video data signal with the coded video data.

In one example embodiment of the present invention, the video coder may code source video data based on the capacity of the decoding device. For a particular type of decoding device, the coding device may determine whether the decoding device has the computational resources to carry out the block-based deblocking filtering process without degrading visual quality. In the case where the decoding device does not have sufficient resources, the coding device may estimate block-based filtering strengths on behalf of the decoder and code the deblocking filter strengths in the bitstream. Therefore, the decoder may perform block based deblocking filtering without the need for estimating deblocking filter strengths.

In another embodiment of the present invention, based on the capacity of the decoder, the coder may change the size of pixel blocks. In predictive coding, pixels may be transformed based on pixel blocks (or transform blocks). Since block artifacts tend to appear at the edges of these pixel blocks, deblocking filters may be applied over edges of these pixel blocks. Smaller pixel blocks may produce higher display quality after deblocking filtering at higher processing cost. On the other hand, larger pixel blocks for deblocking filters may require less processing at the cost of lower display quality. The coder may make a determination of the pixel block sizes based on decoder's capacity and code at an appropriate level of block sizes.

Furthermore, in one embodiment of the present invention, the coder may also determine the decoder's capability for parallel processing. If the decoder is capable of parallel computing, the coder may remove certain deblocking filtering dependencies to take full advantage of the decoder's capability for parallel processing.

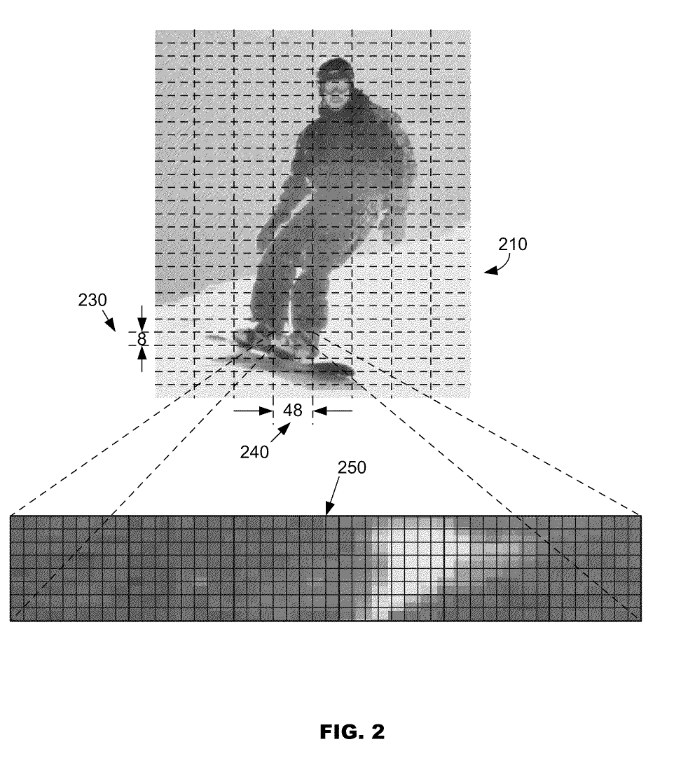

FIG. 2 illustrates a coded image 210 that is split into slices. An image 210 may be split into multiple slices 250. The slices 250 may include a sequence of macroblocks (not shown) of pixels, e.g., 16×16 pixels under H.264. The macroblocks may further include arrays of pixel blocks (e.g., 4×4 or 8×8 pixels). It is an objective of the present invention to control deblocking filter strengths at block level.

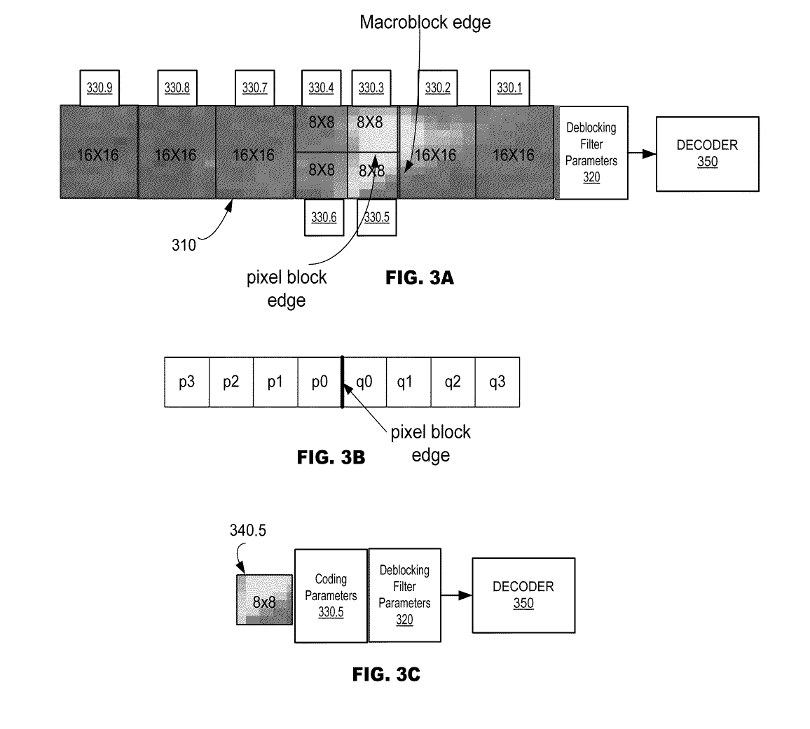

FIG. 3A illustrates a slice that includes macroblocks and pixel blocks. The slice may contain macroblocks 310 (e.g., of 16×16 pixels), which may further contain pixel blocks (e.g., of 8×8 or 4×4 pixels). Adjacent macroblocks may be separated by macroblock edges, and adjacent pixel blocks may be separated by pixel block edges. As shown in FIG. 3A, at the boundaries of macroblocks, pixel block edges may overlay with macroblock edges.

FIG. 3B illustrates a convention for describing pixels across a pixel block edge over which a deblocking filter may apply. Pixel blocks may be 8×8 or 4×4. Thus, the deblocking filter may be a horizontal or vertical, one-dimensional filter with a base of, e.g., 4 or 8 pixels. The example illustration of FIG. 3B includes pixels p₀ . . . p₃ in a first pixel block and q₀ . . . q₃ in a second pixel block. The deblocking filter may be individually applied to each component plane, e.g., the luma and the two chroma under H.264, of a picture frame.

Some of the deblocking filter's parameters may be determined at the coder end. For example, the deblocking filter parameters 320 may include the alpha and beta parameters in the H.264 standard that may be applied globally to a slice of pixels. An H.264 coder commonly computes the alpha and beta parameters that may be applied to all macroblocks within the slice. These global parameters 320 may be centrally stored for the slice with other control parameters for the slice.

For each pixel block edge, the decoder may compute a deblocking filter strength with respect to the pixel block edge. For example, under H.264, the decoder may estimate the deblocking strength (referred to as bS in H.264) at one of four levels based on a number of factors including, e.g., whether p₀ and q₀ are in different macroblocks, the slice type, or intra macroblock prediction mode etc. However, when the decoder has only limited processing resources, the computation of deblocking filter strengths may overburden the decoder.

In one embodiment of the present invention, upon a determination of decoder's limited processing capability (e.g., by comparing the decoder device with a known list of limited-resource devices), the coder may compute the deblocking filter strengths for pixel block edges on behalf of the decoder. The coder may compute the deblocking filter strengths based on pixel blocks that form a pixel block edge. Referring to FIG. 3A, the coder may code the deblocking parameters, including deblocking strengths, along with the coding parameters 330.1-330.9 for each pixel block. In one example embodiment, the coder may first code a video source into, e.g., a H.264 complied, bitstream. A custom coder may estimate deblocking parameters, e.g., deblocking filter strengths (bS) in H.264. Referring to FIG. 3C, these deblocking filter parameters may be again coded with coding parameters 330.5 for the pixel block and transmitted to the decoder at the receiving end.

FIG. 3C illustrates one block 340.5 of the slice of FIG. 3A. The block 340.5 may be a part of the slice 310 which may include deblocking filter parameters 320. The block 340.5 may also include coding parameters 330.5, which may include the coarseness of the quantization used, the number of reference frames referenced by the block, and the number of coded coefficients used. Additionally, block 340.4 may have been predicatively coded based on other blocks. The deblocking filter parameters 320 and the coding parameters 330.5 may be transmitted to the decoder 350 to determine the deblocking filter strengths to be applied to the block 340.5.

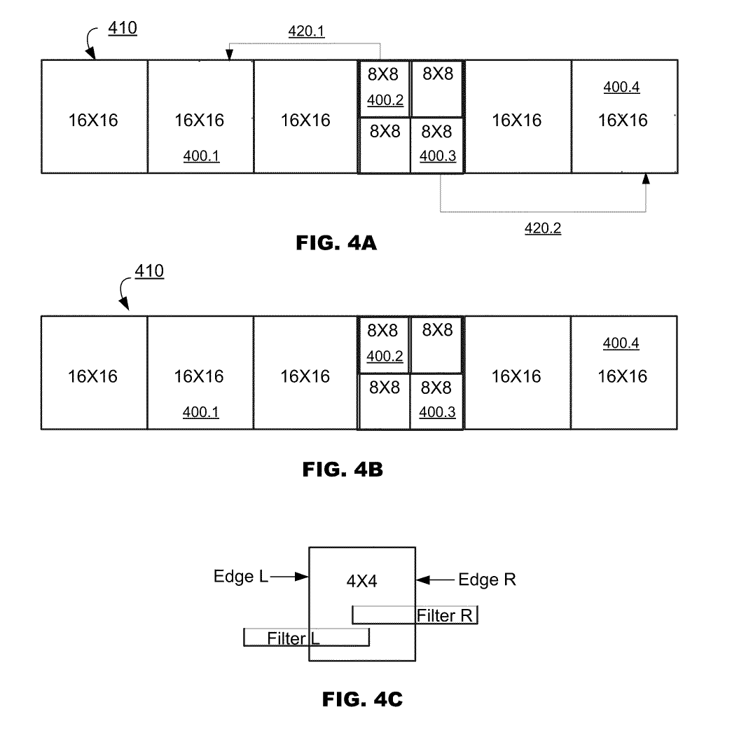

FIG. 4A illustrates a slice 410 of coded video data with data dependencies 420, and FIG. 4B illustrates the data dependencies 420 having been removed. FIG. 4A illustrates a slice 410 of the source video data after being coded. Blocks 400.2 and 400.3 may have been predicted from a portion of block 400.1 and 400.2 respectively. Because of the prediction coding of the blocks 400.2 and 400.3, a deblocking filter at the decoder could not apply deblocking to block 400.3 until block 420.2 had been deblocked and could not apply deblocking to block 400.2 until block 400.1 had been deblocked. After a determination of decoder's capability, the coder may change the type of coding applied to blocks 400.2 and 400.3. Therefore, under certain situations, it may be desirable, rather than predicatively coding blocks 400.2 and 400.3, but intra-coding them based on pixels respectively within the blocks 400.2 and 400.3. FIG. 4B illustrates the slice 410 after the coder has changed the coding scheme for blocks 400.2 and 400.3. The dependencies have been removed so that blocks 400.1-400.4 could be deblocked in parallel at the decoder.

Data dependency may also occur when the length of the deblock filter is longer than half of the pixel block size. Referring to FIG. 4C, a 4×4 pixel block may have an Edge L on the left and an Edge R on the right. A deblocking Filter L may be used to filter the Edge L, and a deblocking Filter R may be used to filter the Edge R. When the length of the deblocking filters is longer than half of the block size, the two filters for two adjacent edges (e.g. Filters L and R) may overlap each other. Thus, the computation of Filter L may depend on the result of Filter R or vice versa. To remove this type of filtering dependency, in one embodiment, the coder may choose to use larger macroblock sizes to avoid the overlapping deblocking filter problem. For example, if the deblocking filter size is 3 taps long for a 4×4 block, the coder may instead choose to use a larger macroblock such as 8×8 to avoid the overlapping deblocking filter problem.

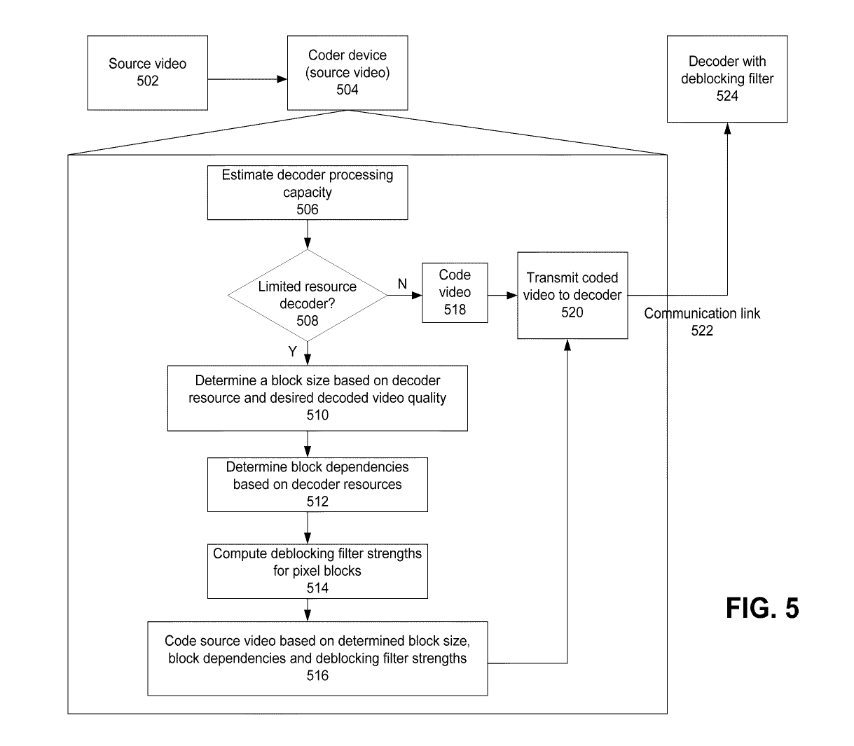

FIG. 5 illustrates an embodiment of joint optimization of complexity and visual quality of the deblocking process for resource limited decoder devices. This embodiment may include an coder device 504, a decoder 524, and communication link 522 for transmitting data between the coder and the decoder. In different embodiments, the coder and the decoder may be implemented in hardware. For example, the decoder may be a device having special purpose chipsets for video coding and decoding. The coder and decoder may also be implemented as software coder or decoder running on a general purpose processor. The coder and decoder may also be implemented as a mix of software and hardware, such as software coder with hardware decoder (or vice versa). The communication link may be wired or wireless. The coded video may be transmitted to the decoder via storage media such as memory storage devices or optical disks.

In one embodiment, source video 502 may be provided to the video coder 504 to be coded for a decoder 524. Responsive to receiving the source video, the coder may acquire knowledge of the intended decoder. The processing resource at the decoder may be related to, e.g., computational power available at the decoder including speed and memory of a processor (CPU and GPU), or the number of processors available for parallel computations. In one embodiment, the processing resource at the decoder may be estimated at 506 based on a type of the decoder device, e.g. via an identification matching to a specific type of hardware device. Different device models may correspondingly have different identification numbers. In another example embodiment, the coder device may estimate the decoder capacity at 506 based on a sampling of decoder hardware resources including models of processors and the number of processors. The coder device may make the estimation by comparing the available hardware with a pre-formulated table. In yet another example embodiment, the coder device may have a pre-compiled list or table of known decoder devices. Then, the coder device may customize video coding based on a particular type of decoder.

At 508, based on information of the decoder, the coder device may make a determination of whether the decoder has sufficient resources for deblocking filtering. In making this determination, the coder may also take into account of the displaying quality of the decoded video. For example, a low resolution displaying device, e.g., a handheld device, may require less deblocking filtering and thus less resources from the decoder. On the other hand, a high resolution displaying device, e.g., a HD monitor, may require more deblocking filtering and thus more resources from the decoder. The display quality of decoded video may also be related to frame drop rate at the decoder. Deblocking filtering may demand so much computational resources that the decoder may need to drop frames from display. The frame drop rate for a particular hardware configuration may be predetermined by experimenting different deblocking filters on the hardware. Therefore, the determination of whether the decoder resource is limited is based on the hardware configuration of the decoder and the desired display quality of the video. In another example embodiment, the determination may additionally depend on the complexity of the source video itself.

If the coder device determines that the decoder has sufficient resources for deblocking filtering and displaying decoded video at the desired quality, the coder device may code the source video using a default coding policy at 518 and transmit the coded video to the decoder at 520 via a communication link 522. The default coding policy may be designed to achieve the most efficient coding, e.g., the most compact video bitstream.

If the coder device determines at 508 that the decoder is a limited resource device for deblocking filtering, the coder device may customize the coding policy of the source video based on the available resources at the decoder. The coding policy may include tunable parameters or factors including but not limited to transform block sizes, tradeoff between inter and intra macroblock, the number of coded parameters, macroblock qp, and Q Matrix. By tuning these factors for a group of macroblocks, the complexity level and visual quality of deblocking filtering may be jointly optimized.

In one example embodiment, at 510, the coder device may determine sizes of pixel blocks in the coded video bitstream. As discussed above in connection with FIG. 3A, the edges of pixel blocks may determine where deblocking filtering may be applied to. The smaller sizes the pixel blocks may be, the more resources the decoder may use for deblocking filtering. The larger sizes the pixel blocks may be, the less resources the decoder may use for deblocking filtering. Thereby, the coder device may increase sizes of pixel blocks used in coding the source video if the coder device has determined that the decoder has limited resources for deblocking filtering. In one example embodiment, the coder device may increase the average size of pixel blocks to a target value. In another example embodiment, the coder device may control the sizes of pixel blocks equal to or larger than a threshold value, e.g., 4×4.

In one embodiment, at 512, the coder device may determine the amount of block dependencies in the code video bitstream based on the resources available at the decoder. As discussed above in connection with FIG. 4C, when the deblocking filters for two adjacent edges overlap each other, the deblocking filtering at one edge may depend on the deblocking filtering on another. As such, the deblocking filtering for some of these depending edges may not happen until the depended on edges have been processed, which may hinder parallel processing for the deblocking filtering. Therefore, for decoders that contains hardware capable of parallel computation, e.g., multiple processors or multiple cores CPU/GPU, the coder device may change the macroblock size so that there is no dependencies between adjacent edges.

In one embodiment, at 514, upon a determination that the decoder may have limited resources for computing the deblocking filter strengths, the coder device may compute the deblocking filter strengths (e.g., bS under H.264) on behalf of the decoder. As discussed above in connection with FIGS. 3A-C, the deblocking filter strengths may be computed concurrently with the coding of pixel blocks. For example, the coder may code the source video and compute deblocking filter strengths based on the coding parameters. The coding parameters that may influence the deblocking filter strengths under, e.g., H.264, may include the locations of p₀ and q₀ (referring to FIG. 3A, whether the pixel block edge is also macroblock edge) and the coding type of a slice (e.g., slice_type under H.264). The deblocking filter strengths may be transmitted separately as extra information to the decoder, or alternatively along with other deblocking filter parameters 320 to the decoder.

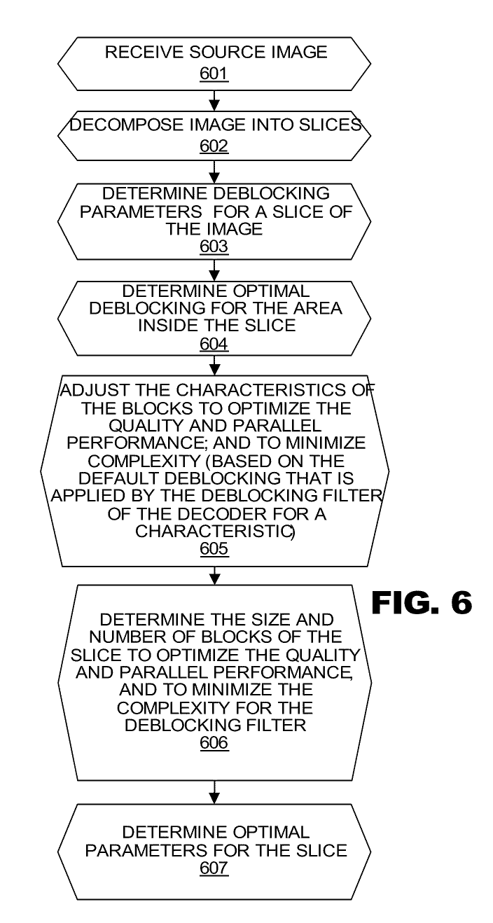

FIG. 6 illustrates another example embodiment of joint optimization of complexity and visual quality of the deblocking process for resource limited decoder devices. At 601, the encoder receives image frames of source video. At 602, an image frame may be further divided into slices of pixels. At 603, the parameters of deblocking filters for slices of pixels may be determined. These parameters may influence globally all pixels within a slice of pixels. At 604, optimal deblocking may be determined for particular areas within the slice. The determination of areas within the slice may involve detecting edges or objects in the image and estimating how much deblocking filtering should be applied to various portions of the slice. For example, it may determine that a wall in the background in the scene may need only low or no deblocking.

At 605, the characteristics of pixel blocks within slices may be adjusted to optimize the deblocking quality and/or minimize the complexity of the deblocking filter. Commonly, the deblocking filter makes default assumptions about how much deblocking to apply based on the characteristics of the blocks (and the set of parameters for the whole slice of pixels). Many factors may be adjusted to achieve the optimized deblocking and complexity. In one example embodiment, the type of neighboring macroblocks (I, P, or B type) may be adjusted for optimal trade-off of quality and complexity. For example, typically, I blocks may receive strong deblocking filtering than inter-coded blocks. To increase a deblocking strength for a block, intra-coded macroblocks (Mbs) may be used. In another example embodiment, the number of coded coefficients may be used to adjust deblocking filter strength. Methods to code coefficients of macroblocks may increase or decrease (or even turn on or off) the deblocking filter strength. For example, when no coefficients are coded for two neighboring inter-coded macroblocks under H.264, the deblocking filter may be weaker than having some coefficients in either neighboring macroblock coded. Thus, by controlling the number of coded coefficients for two adjacent macroblocks, the strengths and complexity of the deblocking may be optimized. Other factors including but not limited to reference picture, number of reference frames, and different motion vector values may also be adjusted to optimize the strength and complexity of deblocking filter.

The method described above may use a state machine to keep track of the complexity that is being used by the deblocking filter of the decoder. The state machine may track previous blocks since there are buffers in the decoder and since a previous slice may increase power, cpu or gpu cycle or time to deblock the current slice. The overall deblocking power/resources are usually limited and usually relate to the complexity of the group of Mb/slice/picture and the current state when starting to deblock the current frame. When the deblocking filter resources at the target decoder are insufficient to performed the expected deblocking, sub-optimal decode performance will be achieved, e.g., frame dropping, drifting, etc. The encoder can have a complexity budget model for the deblocking filter to keep track of the state of the de-blocker at any time. The encoder will keep track of the deblocking filter state by combining the information of the initial state and the complexity of the Mb groups/slice/pictures. Thus, it may ensure that the deblocking filter can have enough resources to complete all the necessary work. Other techniques may be included as part of the complexity control of the encoder to insure the deblocking filter of the decoder is not overtaxed.

At 506, a slice of pixels may be divided into a number of pixel blocks, the size and the number of which may be adjusted to achieve optimized quality and complexity of deblocking filtering at the target decoder. In typical implementation, the smaller the pixel block sizes, the more complex the deblocking filter may be.

In one embodiment of the present invention, quantization parameters may also be adjusted for optimized deblocking filtering at the target decoder. For example, the quantization parameter (q) may also determine the strength of the deblocking filter at the target decoder. The quantization parameter may be adjusted by applying a scalar to the matrix of quantized coefficients (QMatrix). For example, q=30 may mean strong deblocking strength. For this quantization parameter, the method and apparatus of the present invention may determine that an area in a slice should not be deblocked (or not as strongly as p=30), or there is insufficient capabilities at the target decoder for a deblocking strength corresponding to q=30. Thus, the encoder may reduce the quantization parameter (e.g., q=6) and therefore the deblocking strength. The QMatrix may be adjusted accordingly to achieve the effective q=30.

At 607, the overall optimal parameters may be determined for the whole slice of pixels. These parameters may include the alpha and beta for the deblocking filter of the target decoder to use for the slice.

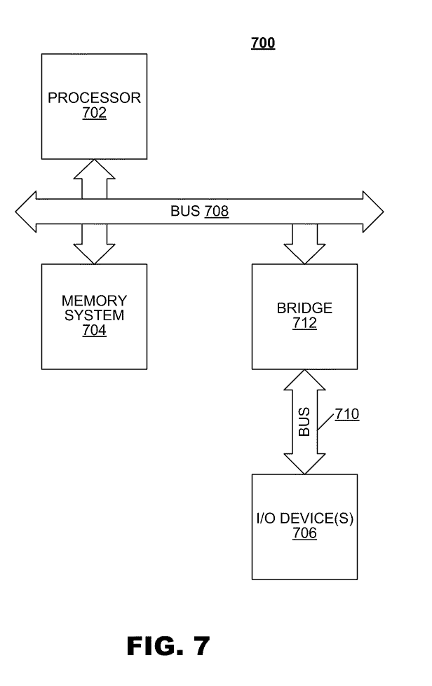

FIG. 7 is a simplified functional block diagram of a computer system 700. A coder and decoder of the present invention can be implemented in hardware, software or some combination thereof. The coder and or decoder may be coded on a computer readable medium, which may be read by the computer system of 700. For example, an coder and/or decoder of the present invention can be implemented using a computer system.

As shown in FIG. 7, the computer system 700 includes a processor 702, a memory system 704 and one or more input/output (I/O) devices 706 in communication by a communication ‘fabric.’ The communication fabric can be implemented in a variety of ways and may include one or more computer buses 708, 710 and/or bridge devices 712 as shown in FIG. 7. The I/O devices 706 can include network adapters and/or mass storage devices from which the computer system 700 can receive compressed video data for decoding by the processor 702 when the computer system 700 operates as a decoder. Alternatively, the computer system 700 can receive source video data for coding by the processor 702 when the computer system 700 operates as a coder.

It should be understood that there exist implementations of other variations and modifications of the invention and its various aspects, as may be readily apparent to those of ordinary skill in the art, and that the invention is not limited by specific embodiments described herein. Features and embodiments described above may be combined. It is therefore contemplated to cover any and all modifications, variations, combinations or equivalents that fall within the scope of the basic underlying principals disclosed and claimed herein.

We claim:

1. A video coding method, comprising:
coding a source video sequence according to a block-based coding process;
estimating processing capabilities of a target decoder;
determining if the estimated processing capabilities are sufficient to perform deblocking filtering, and
if not:
computing deblocking filter strengths for pixel blocks of the source video sequence to be used at decoding; and
transmitting the deblocking filter strengths in a coded video data signal with the coded video data.

2. The method of claim 1, further comprising:
if the processing capacities are sufficient to perform deblocking filtering:
coding the source video with a default coding policy, the default coding policy including default coding parameters; and
transmitting the coded video.

3. The method of claim 1, wherein estimating the processing capacities of the target decoder is based on a hardware configuration at the target decoder and a display quality of decoded video at the target decoder.

4. The method of claim 3, wherein the hardware configuration is determined by a type of decoder processor.

5. The method of claim 3, wherein the hardware configuration is determined by a number of decoder processors.

6. The method of claim 3, wherein a factor of the display quality is display resolution at the target decoder.

7. The method of claim 3, wherein a factor of the display quality is a frame drop rate at the decoder.

8. The method of claim 1, wherein the video is coded under H.264 standard.

9. The method of claim 1, wherein the video is coded under MPEG standards.

10. The method of claim 1. wherein the deblocking filter strengths are at one of four levels.

11. The method of claim 1, wherein the computed deblocking filter strengths are coded as part of coding parameters of the coded video.

12. A video coding method, comprising:
coding a source video sequence according to a block-based coding process;
estimating processing capabilities of a target decoder;
determining if the estimated processing capabilities are sufficient to perform deblocking filtering, and
if not:
determining a pixel block size based on the estimated processing capabilities;
and
coding the video according to the determined pixel block size.

13. The method of claim 12, wherein the determined pixel block size is an average pixel block size for coding the video.

14. The method of claim 12, wherein the determined pixel block size is a minimum pixel block size for coding the video.

15. A video coding method, comprising:
coding a source video sequence according to a block-based coding process;
estimating processing capabilities of a target decoder;
determining whether the target decoder has parallel processing capabilities;
if so,
removing filtering dependencies in the coded video; and
transmitting coded video to the target decoder.

16. A video coding method, comprising:
coding a source video sequence according to a block-based coding process;
estimating processing capabilities of a target decoder;
determining whether the target decoder has parallel processing capabilities;
if so, for a macroblock, determining whether a first deblocking filter for a first edge of the macroblock overlaps with a second deblocking filter for a second edge of the macroblock;
if so,
increasing the size of the macroblock so that the first and second deblocking filters do not overlap; and
coding pixels in the increased macroblock.

17. A video coding method, comprising:
coding a source video sequence according to a block-based coding process;
estimating processing capabilities of a target decoder;
determining if the estimated processing capabilities are sufficient to perform deblocking filtering, and
if not, for a slice of pixels,
adjusting a type of at least one macroblock in the slice of pixels;
coding the video according to the adjusted macroblock type.

18. The video coding method of claim 17, wherein the adjustment is from an I type macroblock to a P type macroblock.

19. The video coding method of claim 17, wherein the adjustment is from an I type macroblock to a B type macroblock.

20. The video coding method of claim 17, wherein the method is applied on a frame basis.

21. A video coding method, comprising:
coding a source video sequence according to a block-based coding process;
estimating processing capabilities of a target decoder;
determining if the estimated processing capabilities are sufficient to perform deblocking filtering, and
if not, for a default quantization parameter value,
adjusting the default quantization parameter value such that complexity of deblocking filtering at the target decoder is reduced;
adjusting a quantization matrix to compensate the adjusted quantization parameter; and
coding the video according to the adjusted quantization parameter and quantization matrix.

22. A video coding system for coding source video based on information of resources at a target decoder, comprising:
a video coder for coding the source video according to a block-based coding process;
a deblocking estimator to:
estimate processing capabilities of a target decoder to receive coded video data;
determine if the estimated processing capabilities are sufficient to perform deblocking filtering, and
if not, compute deblocking filter strengths for pixel blocks of the source video sequence to be used at decoding;
a transmitter unit to transmit the coded video and the deblocking filter strengths to a channel.

23. A computer-readable medium coded with a computer-executable program to perform a video coding method, comprising:
coding a source video sequence according to a block-based coding process;
estimating processing capabilities of a target decoder;
determining if the estimated processing capabilities are sufficient to perform deblocking filtering, and
if not:
computing deblocking filter strengths for pixel blocks of the source video sequence to be used at decoding; and
transmitting the deblocking filter strengths in a coded video data signal with the coded video data.
